(19) United States
(12) Patent Application Publication
(10) Pub. No.: US 2026/0198744 A1
(43) Pub. Date: Jul. 16, 2026

(54) Cleaning Wipes

(71) Applicant: Wayne Desmond Burgis, Miami (AU)

(72) Inventor: Wayne Desmond Burgis, Miami (AU)

(21) Appl. No.: 19/447,371

(22) Filed: Jan. 13, 2026

(30) Foreign Application Priority Data
Jan. 13, 2025 (AU) 2025900081

(51) Int. Cl. A47L 13/17; A47J 37/07; A47L 13/42; B29C 65/00; B29C 65/08; B29K 67/00; B29K 601/00; B29L 31/00

(52) U.S. Cl. CPC A47L 13/17; A47J 37/0786; A47L 13/42; B29C 65/08; B29C 66/712; B29C 66/729; B29K 2067/046; B29K 2601/08; B29K 2995/006; B29L 2031/7406

(57) ABSTRACT

A cleaning wipe comprising: a fabric substantially comprising viscose yarn, the pliable fabric comprising an outer layer having an outer cleaning surface configured for contacting and wiping a surface being cleaned during use; the outer cleaning surface comprising a plurality of biodegradable abrasive nodules bonded to the outer layer, the nodules being distributed across the outer cleaning surface wherein the nodules comprise a width that is at least as great as a height of the nodule.

### RELATED APPLICATION

This application claims priority to AU Patent Application No. 2025900081 filed Jan. 13, 2025, which is incorporated herein by reference in its entirety.

### TECHNICAL FIELD

The present invention relates to the field of cleaning. This invention particularly relates to the field of cleaning wipes that can be used for cleaning dirty surfaces.

### BACKGROUND

Any references to methods, apparatus or documents of the prior art are not to be taken as constituting any evidence or admission that they formed, or form part of the common general knowledge.

Cleaning of food and/or cooking surfaces is an important step to ensure cleanliness and hygiene. Certain surfaces are particularly susceptible to retaining oil residue that form thereon during cooking. A barbeque is one such device that is particularly susceptible to oil residue and char build up. Ensuring that such oil residue and char buildup is removed is important to ensure that hygiene is maintained. It is also important to remove such residue and build up to ensure that the taste of the food is not affected. It is also important to ensure that the oil residue and char build up is removed to maintain the longevity of the surface or assembly thereof.

One available solution is wipes that are particularly designed to remove grease and grime. These wipes typically contain nodules that are 25 specifically designed to loosen the grease and grime whilst the wipe or cloth absorbs/traps grease.

Standard plastic nodules utilized in the presently available wipes have a number of drawbacks. In this regard, these nodules are typically not biodegradable. One of the biggest problems with the use of plastics is with their disposal since they are not biodegradable or have very low rates of degradation.

It would be advantageous to address one or more of the above issues and/or to provide the consumer with a commercial alternative to the presently 5 available solutions

### SUMMARY OF INVENTION

In an aspect, the invention provides a cleaning wipe comprising:
a fabric substantially comprising viscose yarn, the pliable fabric comprising an outer layer having an outer cleaning surface configured for contacting and wiping a surface being cleaned during use;
the outer cleaning surface comprising a plurality of biodegradable abrasive nodules bonded to the outer layer, the nodules being distributed across the outer cleaning surface wherein the nodules comprise a width that is at least as great as a height of the nodule.

In an embodiment, the biodegradable abrasive nodules comprise melted and cured poly lactic acid (PLA).

In an embodiment, the biodegradable abrasive nodules are ultrasonically welded to the outer layer of the pliable fabric.

In an embodiment, the abrasive nodules comprise 20 wt % to 40 wt % of the cleaning wipe.

In an embodiment, the abrasive nodules further comprise one or more of the following coatings: cleaning agent; fragrance agents.

In an embodiment, the fabric comprises a plurality of fabric layers and wherein the biodegradable abrasive modules are bonded to one or more of said fabric layers.

In an embodiment, the biodegradable abrasive modules are ultrasonically bonded to one or more said fabric layers.

In an embodiment, the fabric comprises at least 50 wt % viscose and preferably at least 80 wt % viscose.

### DETAILED DESCRIPTION OF PREFERRED EMBODIMENTS

Embodiments of the present invention reside primarily in the combination of the biodegradable abrasive nodules and a fabric to form an improved cleaning wipe.

The cleaning wipe comprises a pliable fabric that substantially comprises viscose. The fabric described herein made from a flexible material comprising a network of fibres often referred to as yarn or thread. A yarn is produced by spinning fibres. A thread is produced by twisting two or more yarns together. Further, fabrics may be classified into three categories woven, knitted and non-woven fabrics. The presently described fabric may be made substantially from viscose and may be woven, knitted or non-woven to produce a pliable fabric with two outer layers separated by one or more intermediate layers. In other embodiments, the fabric may also the take the form of a single layered fabric with an outer surface. The disposable cleaning cloths described herein may be relatively lightweight, while providing superior cloth strength and cleaning ability in a disposable format.

The outer surface of the fabric comprises a plurality of abrasive nodules made some biodegradable material. In the preferred embodiment, the abrasive modules may be made from a biodegradable polymer such as but not limited to PLA (Poly Lactic Acid). PLA pellets may be heat melted, and then small droplets of the heat melted PLA may be applied onto the outer surface of the fabric. It is desirable to have nodules that have a width or diameter which is greater than the height of each nodule. A spraying mechanism such as an ultra-fine spray mechanism may be used for spraying the heat melted PLA across the outer layer or outer surface of the pliable fabric. Thereafter, ultrasonic welding may be used to ensure that the sprayed PLA droplets are bonded onto the one or more layers of the fabric. The fabric that forms the cleaning wipe may comprise a bottom layer and a top layer. The top layer may receive the abrasive modules as described above.

Once the PLA has been sprayed onto the top layer of the fabric, the fabric may be rolled on heated rollers to assist with bonding or adhesion of the abrasive nodules before undertaking ultrasonic welding. The distribution and quantity of abrasive modules may be varied depending on the end-use of the cleaning wipes. The abrasive nodules comprise may be 10 wt % to 50 wt % of the cleaning wipe. For example, when the abrasive modules form 50 wt % of the cleaning wipe, it may be suitable for cleaning hands via abrasive or frictional action. In other examples, the abrasive modules may be 27 wt % which may be more suitable for domestic cleaning applications such as wiping dirty surfaces in the kitchen or bathroom. The abrasive modules may be increased to 35 wt % for industrial cleaning wipes. The cleaning wipe described herein is not limited by the size, number/quantity or distribution of the abrasive nodules.

The inventor(s) have found that embodiments of the cleaning wipes described herein have greater levels of biodegradability and meets the requirements of partial and even full biodegradability. Readily biodegradable wipes are highly desirable since the abrasive biodegradable nodules were found to undergo rapid biodegradation without any intervention. In the past, cleaning products with non-biodegradable nodules (or larger particles) were found to be not water soluble and remained in particulate form for very longer periods before breaking down into microplastic particles. The cleaning wipes and the abrasive nodules in particular undergo biodegradation and as a result are less likely to cause problems in waste treatment and eventually may be deposited in soil or landfills.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A cleaning wipe comprising:
a fabric substantially comprising viscose yarn, the pliable fabric comprising an outer layer having an outer cleaning surface configured for contacting and wiping a surface being cleaned during use; and
the outer cleaning surface comprising a plurality of biodegradable abrasive nodules bonded to the outer layer, the nodules being distributed across the outer cleaning surface wherein the nodules comprise a width that is at least as great as a height of the nodule.

2. A cleaning wipe in accordance with claim 1, wherein the biodegradable abrasive nodules comprise melted and cured poly lactic acid (PLA).

3. A cleaning wipe in accordance with claim 1, wherein the biodegradable abrasive nodules are ultrasonically welded to the outer layer of the pliable fabric.

4. A cleaning wipe in accordance with claim 1, wherein the abrasive nodules comprise 10 wt % to 50 wt % of the cleaning wipe.

5. A cleaning wipe in accordance with claim 1, wherein the abrasive nodules further comprise one or more of the following coatings: cleaning agent; fragrance agents.

6. A cleaning wipe in accordance with claim 1, wherein the fabric comprises a plurality of fabric layers and wherein the biodegradable abrasive modules are bonded to one or more of said fabric layers.

7. A cleaning wipe in accordance with claim 6, wherein the biodegradable abrasive modules are ultrasonically bonded to one or more said fabric layers.
